(19) United States
(12) Patent Application Publication
(10) Pub. No.: US 2016/0134972 A1
(43) Pub. Date: May 12, 2016

(54) LOUDSPEAKER-PURPOSE VIBRATION PLATE, LOUDSPEAKER USING THAT VIBRATION PLATE, ELECTRONIC DEVICE, AND MOBILE APPARATUS

(71) Applicant: PANASONIC INTELLECTUAL PROPERTY MANAGEMENT CO., LTD., Osaka (JP)

(72) Inventors: TOMONORI SHIBUYA, Okayama (JP); YOSHIMICHI KAJIHARA, Okayama (JP); YOSHIYUKI TAKAHASHI, Okayama (JP); YOHEI JIN, Mie (JP); SATORU TANAKA, Mie (JP)

(21) Appl. No.: 14/898,480

(22) PCT Filed: Jul. 17, 2014
(86) PCT No.: PCT/JP2014/003794

§ 371 Date: Dec. 15, 2015

(30) Foreign Application Priority Data
Jul. 25, 2013 (JP) 2013-154252

(51) Int. Cl. H04R 7/06; H04R 9/04; H04R 7/18

(52) U.S. Cl. CPC H04R 7/06; H04R 7/18; H04R 9/04; H04R 2307/029

(57) ABSTRACT

A loud speaker diaphragm includes a base layer containing a natural fiber, and a coating layer composed of a cellulose nanofiber. The coating layer is formed on at least one surface of the base layer. A Young's modulus of the cellulose nanofiber is larger than a Young's modulus of the base layer, and an internal loss of the cellulose nanofiber is smaller than an internal loss of the base layer.

### TECHNICAL FIELD

The present invention relates to a loudspeaker diaphragm, a loudspeaker using the diaphragm, an electronic device, and a mobile apparatus.

### BACKGROUND ART

A conventional loudspeaker diaphragm includes a base layer, and a coating layer. The base layer is made by making a paper from natural fibers. For example, wood pulp can be used as the natural fibers.

The coating layer is formed on one surface of the base layer. The coating layer contains bacterial cellulose. Bacterial cellulose is produced by a fermentation process using bacteria. Bacteria for producing cellulose include, for example, Diplodia natalensis, Actinomucor elegans, and Rhizopus oligosporus.

The coating layer is formed by coating the base layer with fluid dispersion containing bacterial cellulose, and drying the applied fluid dispersion layer.

As a prior art reference related to the invention of the present application, Patent Literature 1 is known, for example.

### CITATION LIST

### Patent Literature

PTL 1: Unexamined Japanese Patent Publication No. H05-7393

### SUMMARY OF THE INVENTION

A loudspeaker diaphragm according to the present invention has a base layer containing a natural fiber, and a coating layer composed of a cellulose nanofiber. The coating layer is formed on at least one surface of the base layer. A Young's modulus of the cellulose nanofiber is larger than that of the base layer, and an internal loss of the cellulose nanofiber is smaller than that of the base layer.

As described above, the loudspeaker diaphragm of the present invention has a high elasticity and is capable of preventing the internal loss from being reduced. Further, according to the loudspeaker diaphragm of the present invention, it is possible to increase the adhesion strength between the base layer and the coating layer. As a result, a vibration of the voice coil coupled to the diaphragm can be favorably transmitted to the diaphragm.

### BRIEF DESCRIPTION OF DRAWINGS

FIG. 1A is an image view of a cross-section of a loudspeaker diaphragm in accordance with an exemplary embodiment of the present invention observed by a scanning electron microscope (SEM).

FIG. 1B is a schematic diagram illustrating a part of FIG. 1A.

FIG. 2 is a graph illustrating a sound velocity characteristic of a loudspeaker diaphragm in accordance with an exemplary embodiment of the present invention.

FIG. 3 is a graph illustrating an internal loss of a loudspeaker diaphragm in accordance with an exemplary embodiment of the present invention.

FIG. 4 is a cross-sectional view of another loudspeaker diaphragm in accordance with the exemplary embodiment of the present invention.

FIG. 5 is a cross-sectional view of a loudspeaker in accordance with the exemplary embodiment of the present invention.

FIG. 6 is a conceptual diagram of an electronic device in accordance with the exemplary embodiment of the present invention.

FIG. 7 is a conceptual diagram of a mobile apparatus in accordance with the exemplary embodiment of the present invention.

### DESCRIPTION OF EMBODIMENT

Prior to describing an exemplary embodiment of the present invention, a problem of the conventional loudspeaker diaphragm will be described.

It is preferable that a material used for a loudspeaker diaphragm has a large elasticity and a large internal loss. Accordingly, the bacterial cellulose used for the conventional diaphragm is larger in both Young's modulus and internal loss than the material of the base layer.

However, the bacterial cellulose which is larger in both Young's modulus and internal loss than the material of the base layer is small in the quantity available in the market. Accordingly, it is concerned whether steady supply of the conventional bacterial cellulose will be guaranteed. Also, the conventional bacterial cellulose is expensive. Consequently, the conventional bacterial cellulose is not a material that can be commercially used, although it is favorable in physical characteristics required to be used as a diaphragm.

The present invention solves the above-described problems, and provides a low-cost loudspeaker diaphragm that has a high elasticity, and is able to prevent the internal loss from being reduced.

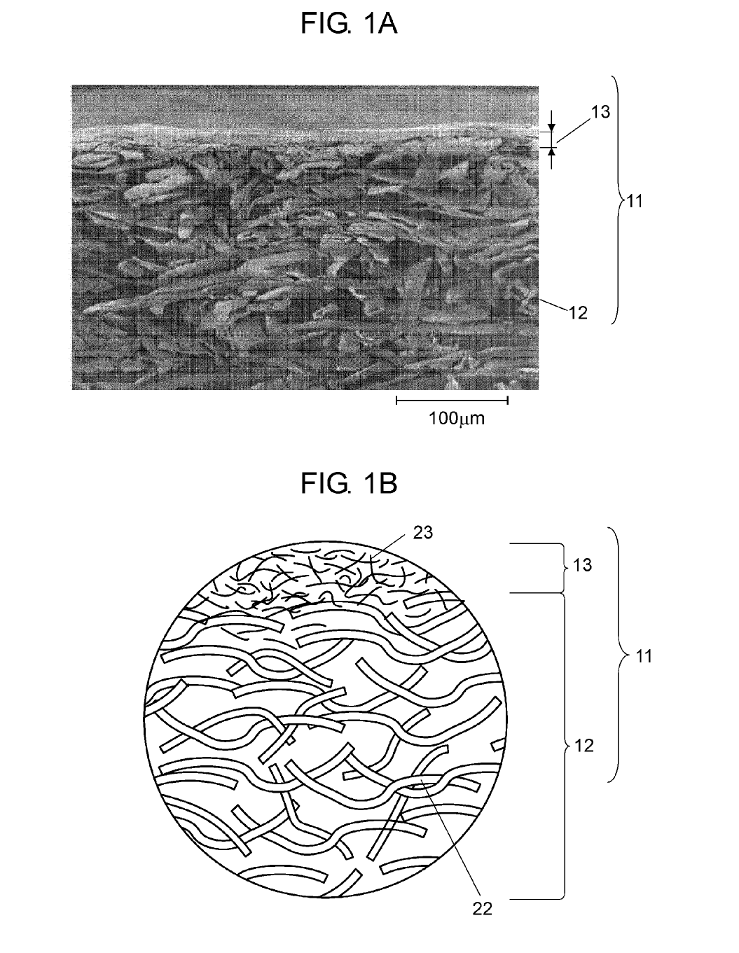

Hereinafter, a loudspeaker diaphragm in accordance with an exemplary embodiment will be described with reference to the drawings. FIG. 1A and FIG. 1B respectively show an enlarged image of a cross-section of loudspeaker diaphragm 11 (hereinafter referred to as diaphragm 11) in accordance with the exemplary embodiment of the present invention observed by a SEM and a schematic diagram illustrating a part of the image. In a case of observing an entire image in the thickness direction of diaphragm 11 by the SEM observation, it is preferable to set the magnification of the SEM at about 100 times. In a case of observing coating layer 13 by the SEM observation, it is preferable to set the magnification of the SEM at about 300 times.

Diaphragm 11 includes base layer 12 and coating layer 13. Base layer 12 contains natural fibers 22. Among the substances composing base layer 12, a main constituent having the highest proportion is natural fiber 22. Natural fiber 22 used for base layer 12 contains cellulose. Materials used as natural fiber 22 include, for example, wood pulp and non-wood pulp. A combination of wood pulp and non-wood pulp may also be used. Non-wood pulp used for base layer 12 is preferably composed of bamboo fibers. Since bamboos are grown in a relatively short period of time, it is possible by use of bamboos to prevent depletion of the forest resources. Accordingly, diaphragm 11 can contribute to preventing destruction of the global environment.

Coating layer 13 is formed on at least one surface of base layer 12. Among the substances composing coating layer 13, a constituent having the highest proportion is cellulose nanofiber 23. Cellulose nanofiber 23 is a nano level fiber containing cellulose. Since both of base layer 12 and coating layer 13 contain cellulose as described above, base layer 12 and coating layer 13 are firmly stuck to each other by hydrogen bonding and anchor effect due to entanglement between celluloses. Fiber diameter of cellulose nanofiber 23 is preferably in a range from 5 nm to 200 nm, inclusive. The above fiber diameters can be observed by the SEM.

Cellulose nanofiber 23 has a Young's modulus larger than a Young's modulus of natural fiber 22, or a Young's modulus of base layer 12. Further, cellulose nanofiber 23 has an internal loss smaller than an internal loss of natural fiber 22, or an internal loss of base layer 12. In other words, a Young's modulus of coating layer 13 is larger than that of base layer 12. Also, an internal loss of coating layer 13 is smaller than that of base layer 12.

Since the Young's modulus of the cellulose nanofiber is high, the stiffness of coating layer 13 can be made high even if the thickness of coating layer 13 is thin. Accordingly, the thickness of coating layer 13 can be made thin. As a result, it is possible to prevent reduction of the internal loss of diaphragm 11 due to providing coating layer 13.

Furthermore, diaphragm 11 can be produced by using cellulose nanofiber, which is relatively inexpensive. Accordingly, diaphragm 11 has a high elasticity and a large internal loss, and is low-cost.

It is preferable to form coating layer 13 on a front surface of base layer 12, which is opposite to a surface facing a space in which a magnetic circuit of a loudspeaker is disposed when diaphragm 11 is built in the loudspeaker. Since coating layer 13 is formed on the front surface of base layer 12 in this configuration, the front surface of diaphragm 11 is glossy. Accordingly, the front surface of diaphragm 11 is very beautiful without sticking a laminate film or the like. As a result, diaphragm 11 is lighter in weight and larger in sound velocity compared to a diaphragm to which a laminate film is stuck.

Further, density of cellulose nanofibers 23 in coating layer 13 is extremely high. In other words, spaces between cellulose nanofibers 23 in coating layer 13 are extremely small. In this configuration, coating layer 13 can prevent water or the like from penetrating into base layer 12. Accordingly, it is not necessary to apply any waterproof treatment to diaphragm 11. Of course, a waterproof treatment may be applied to diaphragm 11. In this case, the thickness of the waterproof film on diaphragm 11 can be made thin. As a result, diaphragm 11 is lighter in weight and larger in sound velocity compared to a diaphragm processed by applying a general waterproof treatment.

The position to form coating layer 13 is not limited to the front surface of base layer 12. For example, coating layer 13 may be formed on the back surface of base layer 12. Further, coating layers 13 may be formed on both of the front surface and the back surface of base layer 13. However, the above-described waterproof effect can be obtained by forming coating layer 13 on at least the front surface of base layer 12.

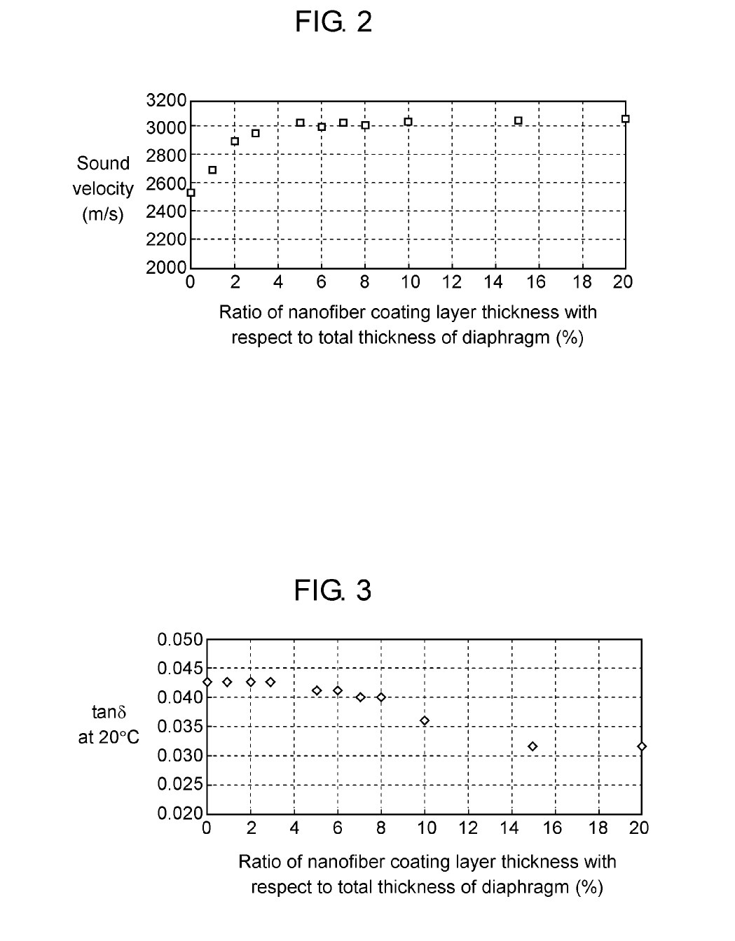

Hereinafter, diaphragm 11 will be described in more detail. FIG. 2 is a graph illustrating a sound velocity characteristic of diaphragm 11. FIG. 3 is a graph illustrating an internal loss of diaphragm 11. The horizontal axis in each of FIG. 2 and FIG. 3 indicates the ratio of the thickness of coating layer 13 to the total thickness of diaphragm 11. On the other hand, the vertical axis in FIG. 2 indicates the value of the sound velocity of diaphragm 11. The vertical axis in FIG. 3 indicates the value of the internal loss of diaphragm 11. Here, the total thickness of diaphragm 11 and the thickness of coating layer 13 are measured by observing the SEM images. The total thickness of diaphragm 11 is measured by setting the magnification of the SEM at 100 times. On the other hand, the thickness of coating layer 13 is measured by setting the magnification of the SEM at 300 times.

As shown in FIG. 2, the increase in the sound velocity of diaphragm 11 reduces sharply when the thickness of coating layer 13 with respect to the total thickness of diaphragm 11 is equal to or larger than 2%. Further, the increase in the sound velocity of diaphragm 11 becomes saturated and stable when the thickness of coating layer 13 with respect to the total thickness of diaphragm 11 is equal to or larger than 3.5%. Although there is no actually measured data corresponding to 3.5% as the thickness of coating layer 13 with respect to the total thickness of diaphragm 11, the above-mentioned value “3.5%” can be derived from the other actually measured values shown in FIG. 2.

On the other hand, as shown in FIG. 3, the reduction of the internal loss of diaphragm 11 is small in a range in which the thickness of coating layer 13 with respect to the total thickness of diaphragm 11 is equal to or smaller than 8%. Particularly, the change in the internal loss of diaphragm 11 is extremely small in a range in which the thickness of coating layer 13 with respect to the total thickness of diaphragm 11 is equal to or smaller than 6%. Accordingly, it is preferable that the thickness of coating layer 13 with respect to the total thickness of diaphragm 11 is in a range from 2% to 8%, inclusive. In this configuration, it is possible to increase the Young's modulus and the sound velocity of diaphragm 11, and to prevent reduction of the internal loss of diaphragm 11. Although coating layer 13 is specified by the thickness ratio in the present exemplary embodiment, coating layer 13 may be specified in other manners without being limited to the thickness ratio. For example, coating layer 13 may be specified by the ratio of the weight of coating layer 13 with respect to the total weight of diaphragm 11. In this case, it is preferable that the weight of coating layer 13 with respect to the total weight of diaphragm 11 is in a range from 4 wt % to 8 wt %, inclusive. As another manner, coating layer 13 may be specified by specific gravity, surface density, or the like. A preferable range of specific gravity or surface density can be calculated from the values of the thickness ratio or the weight ratio.

It is more preferable that the thickness of coating layer 13 with respect to the total thickness of diaphragm 11 is in a range from 3.5% to 6%, inclusive. In this configuration, it is possible to further increase the Young's modulus and the sound velocity of diaphragm 11, and to further prevent reduction of the internal loss of diaphragm 11.

In this case, it is preferable that the internal loss of cellulose nanofiber 23 is equal to or larger than 70% of that of natural fiber 22. In this configuration, it is possible to prevent reduction of the internal loss of diaphragm 11 even if the internal loss of cellulose nanofiber 23 is smaller than that of natural fiber 22.

As cellulose nanofiber 23, it is preferable to use, for example, natal de coco powder or a bamboo nanofiber refined to have a nano-level size. Table 1 below shows values of Young's modulus and internal loss of each of natal de coco powder, bamboo nanofiber, and general wooden natural pulp.

TABLE 1

| | Young's modulus | Internal |
|---|---|---|
| | [MPa] | loss |
| Nata de coco powder | 10,200 | 0.03 |
| Bamboo nanofiber | 9,315 | 0.03 |
| Wooden natural pulp | 2,325 | 0.04 |

Nata de coco powder is composed of nanofibers made from bio-cellulose. Nata de coco powder can be easily produced by, for example, drying gel of natal de coco and grinding the dried product. Nata de coco is also used as food, and thus is easily available in the market. Accordingly, natal de coco powder can be purchased at about JP¥1/g (one Japanese yen per gram) On the other hand, price of the bacterial cellulose having a high internal loss is about five to ten times that of the cellulose nanofiber of natal de coco powder. A described above, the cellulose nanofiber of natal de coco powder is extremely cheap compared to the other bacterial celluloses.

Meanwhile, bamboos, which are raw materials of the bamboo fiber refined to the nano-level, inhabit globally, and grow very quickly. Accordingly, bamboo fibers also are easily available. Further, the process to refine bamboo fiber to the nano-level can be realized by diverting most steps of the existing process for forming bamboo fiber into a microfibril. Accordingly, it is not necessary to introduce a new facility. Also, cellulose nanofiber 23 of the bamboo does not require cultivation of bacteria or the like, differently from bacterial cellulose. Accordingly, cellulose nanofiber 23 of the bamboo fiber refined to the nano-level has extremely high productivity compared to bacterial cellulose. As a result, the bamboo nanofiber refined to the nano-level is extremely cheap compared to bacterial cellulose.

Next, a method for producing diaphragm 11 will be described. Base layer 12 is formed by a papermaking process. Base layer 12 is produced by depositing a mixture of beaten natural fibers 22 and water on a net. Then, cellulose nanofibers 23 are applied to the deposition substance constituting base layer 12. Cellulose nanofibers 23 have preliminarily been mixed with water. Then, the deposition substance and cellulose nanofiber 23 are dewatered by suctioning or the like. Then, the dewatered laminated body of the natural fibers and cellulose nano-fibers is dried and shaped by heating and pressing. In the above-described process, diaphragm 11 having a structure in which coating layer 13 is formed on base layer 12 is completed.

In this case, cellulose nanofibers 23 are applied to the deposition substance which is in the wet state. Accordingly, hydrogen bonding between cellulose in cellulose nanofiber 23 and cellulose in natural fiber 22 can be increased. As a result, Young's modulus of diaphragm 11 can be increased.

Although coating layer 13 is formed by applying cellulose nanofiber 23 to the deposition substance which has not been dewatered in the above process, method for forming coating layer 13 is not limited to such method. For example, coating layer 13 may be formed by applying liquid in which cellulose nanofiber 23 is dispersed to a deposition substance which has been dewatered. In this case, the deposition substance, which has merely been dewatered, contains water. Accordingly, in this case also, hydrogen bonding between cellulose in cellulose nanofiber 23 and cellulose in natural fiber 22 can be increased.

As another method, base layer 12 may be formed by dewatering only the deposition substance, and heating and pressing only the dewatered deposition substance. In this case, cellulose nanofibers 23 are applied to base layer 12 which is in the state that drying and forming processes have been completed. Then, applied cellulose nanofibers 23 are dried. In this case, since base layer 12 is dry, base layer 12 is hardly damaged, so that productivity is good.

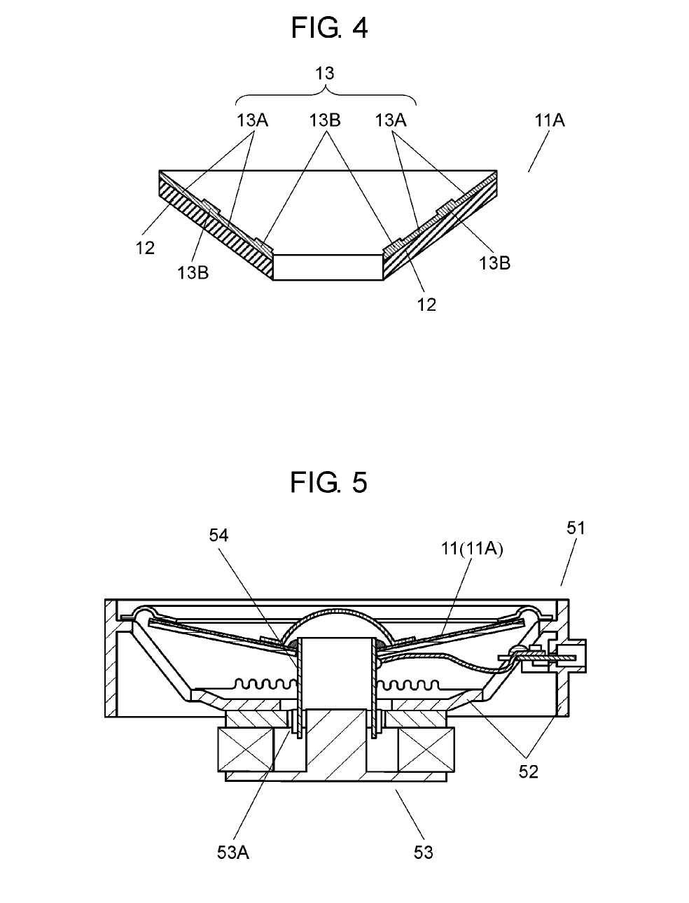

FIG. 4 is a cross-sectional view of another loudspeaker diaphragm 11A in accordance with the exemplary embodiment of the present invention. Coating layer 13 includes first coating part 13A and second coating part 13B. Second coating part 13B is thicker than first coating part 13A. Second coating part 13B is preferably formed at a portion at which divisional resonance is generated. As a result, since the strength of diaphragm 11A becomes large at second coating part 13B, the divisional resonance can be prevented from generating. Accordingly, it is possible to prevent generation of peaks and dips in the sound pressure frequency characteristic of diaphragm 11A.

FIG. 5 is a cross-sectional view of loudspeaker 51 in accordance with the present exemplary embodiment. Loudspeaker 51 includes frame 52, magnetic circuit 53 including magnetic gap 53A, voice coil 54, and diaphragm 11. Magnetic circuit 53 is fixed to frame 52 so as to be coupled to the back side of frame 52 at the center part of frame 52. The outer periphery of diaphragm 11 is connected to the periphery of frame 52. The outer periphery of diaphragm 11 and the outer periphery of frame 52 may be connected via an edge. Voice coil 54 includes a bobbin, and has a first end coupled to the center part of diaphragm 11 and a second end inserted into magnetic gap 53A.

Since the elasticity and the sound velocity of diaphragm 11 is large as described above, loudspeaker 51 can reproduce sounds in a wide frequency range at a large sound pressure level. Further, since reduction of the internal loss of diaphragm 11 is prevented, loudspeaker 51 has a sound pressure frequency characteristic in which generation of peaks and dips is suppressed. Further, since diaphragm 11 is inexpensive, loudspeaker 51 also is cheap in price.

It is preferable that coating layer 13 is formed on the inner periphery including the center part of diaphragm 11 at which the first end of voice coil 54 is coupled. In this configuration, adhesion strength between base layer 12 and coating layer 13 is large at the portion where voice coil 54 is coupled, by hydrogen bonding and the anchor effect due to entanglement of celluloses. Accordingly, vibration of voice coil 54 is favorably transmitted to diaphragm 11. As a result, the sound pressure output from loudspeaker 51 becomes large.

In a case where second coating part 13B is formed on diaphragm 11, it is preferable that the first end of voice coil 54 is coupled to second coating part 13B. The first end of voce coil 54 may not necessarily be coupled to second coating part 13B, but may be coupled to the surface (of base layer 12) opposite to the surface on which second coating part 13B is formed, within an area in which second coating part 13B is formed. Since the thickness of diaphragm 11 becomes thick at the portion at which the first end of voice coil 54 is coupled by forming second coating part 13B on diaphragm 11, the strength of diaphragm 11 becomes larger at the portion at which diaphragm 11 and voice coil 54 are coupled. Accordingly, vibration of voice coil 54 can be favorably transmitted to diaphragm 11. As a result, the sound pressure output from loudspeaker 51 becomes large. Further, it is preferable that coating layer 13 is formed on the front surface of diaphragm 11. This configuration makes the external appearance of loudspeaker 51 beautiful.

Incidentally, the peaks and dips of the sound pressure frequency characteristic can be further suppressed by using diaphragm 11A instead of diaphragm 11.

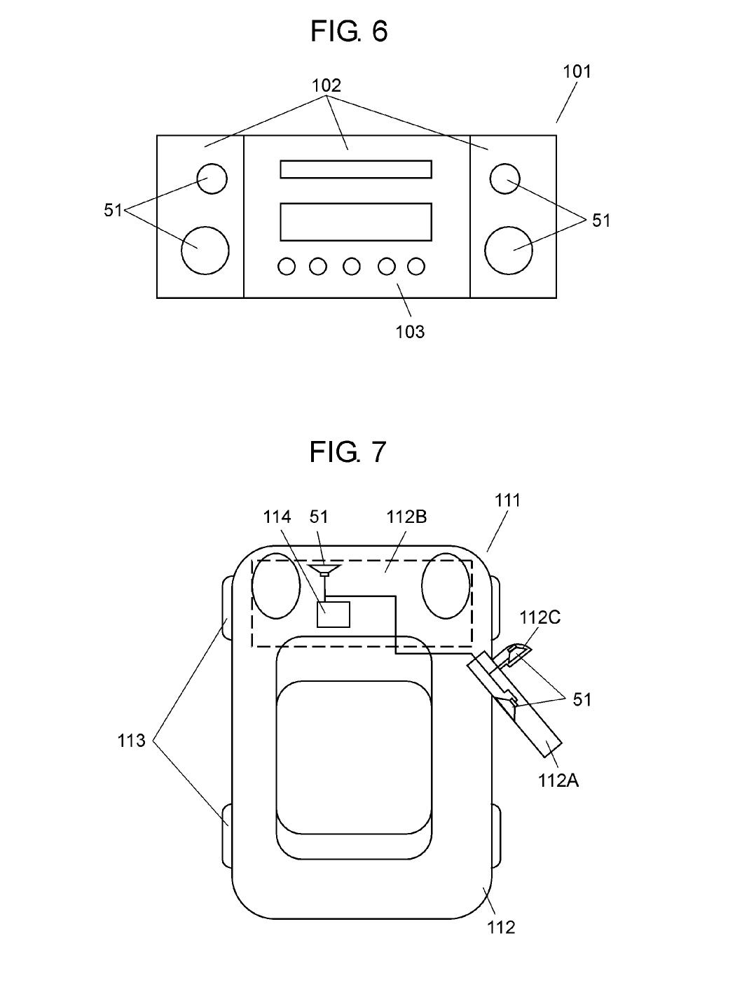

FIG. 6 is a conceptual diagram of electronic device 101 in accordance with the present exemplary embodiment. Electronic device 101 includes housing 102, signal processor 103, and loudspeakers 51. Electronic device 101 is, for example, a stereo component system.

Signal processor 103 is housed in housing 102. Signal processor 103 processes an audio signal. Also, signal processor 103 includes an amplifier. Further, signal processor 103 may include a sound source. In this case, the sound source may include one or more of a CD player, an MP3 player and a radio receiver.

Electronic device 101 is not limited to the component stereo system. For example, electronic device 101 may be a video device such as a television set or the like, a mobile phone, a smart phone, a personal computer, or a tablet terminal. In each of these cases, electronic device 101 further includes a display (not shown). Also, in each of these cases, signal processor 103 performs a video signal processing in addition to the audio signal processing.

Loudspeakers 51 are fixed to housing 102. For example, frame 52 shown in FIG. 5 is fixed to housing 102 with an adhesive or screws. In this configuration, loudspeaker 51 is fixed to housing 102. Housing 102 may be divided to a part for housing signal processor 103 and a loudspeaker boxes for fixing loudspeakers 51. Housing 102 may be an integrated structure for housing signal processor 103 as well as fixing loudspeakers 51.

An output side of signal processor 103 is electrically connected to each of loudspeakers 51. In this case, the output side of signal processor 103 is electrically connected to voice coil 54 shown in FIG. 5. Accordingly, signal processor 103 supplies an audio signal to voice coil 54.

Particularly in electronic device 101, it is preferable that coating layer 13 is formed on the front surface of diaphragm 11 as shown in FIG. 1A. In this configuration, even if diaphragm 11 is exposed from housing 102, the exposed part of diaphragm 11 does not degrade the beauty appearance of electronic device 101.

FIG. 7 is a conceptual diagram of mobile apparatus 111 in accordance with the present exemplary embodiment. Mobile apparatus 111 includes main body 112, driving unit 113, signal processor 114, and loudspeaker 51. Mobile apparatus 111 is not limited to an automobile and may be a railway train, a motorcycle, a boat or ship, and one of vehicles for various services.

Driving unit 113 is mounted to main body 112. Driving unit 113 may include, for example, an engine, a motor, and wheels. Driving unit 113 allows main body 112 to move.

Signal processor 114 is housed in main body 112. Also, loudspeaker 51 is fixed to man body 112. In this case, frame 52 shown in FIG. 5 is fixed to main body 112 with, for example, an adhesive or screws. Accordingly, loudspeaker 51 is fixed to main body 112. Mobile apparatus 111 is, for example, an automobile. Main body 112 may include door 112A, motor room (or engine room) 112B, and side mirror unit 112C. Loudspeaker 51 may be provided to either of door 112A, motor room 112B, and side mirror unit 112C.

An output side of signal processor 114 is electrically connected to loudspeaker 51. In this case, the output side of signal processor 114 is electrically connected to the voice coil shown in FIG. 5. Signal processor 114 may configure a part of a car navigation system or a part of a car audio system. Also, loudspeaker 51 may configure a part of a car navigation system or a part of a car audio system.

Particularly in mobile apparatus 111, it is preferable that coating layer 13 is formed on the front surface of diaphragm 11 as shown in FIG. 1A. In this configuration, even if diaphragm 11 is exposed, the exposed part of diaphragm 11 does not degrade the beauty appearance of the interior of mobile apparatus 111.

In a case where loudspeaker 51 is provided to door 112A, motor room 112B or side mirror unit 112C, it is highly possible that loudspeaker 51 is in contact with rain water. For this reason, it is preferable that coating layer 13 is formed on the front surface of diaphragm 11. In this configuration, coating layer 13 prevent rain water from penetrating into an inner part of loudspeaker 51.

### INDUSTRIAL APPLICABILITY

A loudspeaker diaphragm in accordance with the present invention has advantageous effects in that it has a high elasticity and a high internal loss, and thus is useful when it is applied to loudspeakers mounted to electronic devices and mobile apparatuses.

### REFERENCE MARKS IN THE DRAWINGS

11 diaphragm

11A diaphragm

12 base layer

13 coating layer

13A first coating part

13B second coating part

22 natural fiber

23 cellulose nanofiber

51 loudspeaker

52 frame

53 magnetic circuit

53A magnetic gap

54 voice coil

101 electronic device

102 housing

103 signal processor

111 mobile apparatus

112 main body

112A door

112B motor room

112C side mirror unit

113 driving unit

114 signal processor

1. A loudspeaker diaphragm comprising:
a base layer containing a natural fiber; and
a coating layer formed on at least one surface of the base layer, and composed of a cellulose nanofiber which has a Young's modulus larger than a Young's modulus of the base layer and has an internal loss smaller than an internal loss of the base layer.

2. The loudspeaker diaphragm according to claim 1, wherein the coating layer has a thickness in a range from 2% to 8%, inclusive, of a thickness of the diaphragm.

3. The loudspeaker diaphragm according to claim 1, wherein the coating layer has a thickness in a range from 3.5% to 6%, inclusive, of a thickness of the diaphragm.

4. The loudspeaker diaphragm according to claim 1, wherein the internal loss of the cellulose nanofiber is equal to or larger than 70% and smaller than 100% of an internal loss of the natural fiber.

5. The loudspeaker diaphragm according to claim 1, wherein the cellulose nanofiber is natal de coco powder.

6. The loudspeaker diaphragm according to claim 1, wherein the cellulose nanofiber is a bamboo fiber.

7. The loudspeaker diaphragm according to claim 1, wherein the coating layer is formed on an inner periphery of the diaphragm.

8. The loudspeaker diaphragm according to claim 1, wherein the coating layer includes:
a first coating part; and
a second coating part thicker than the first coating part.

9. The loudspeaker diaphragm according to claim 8, wherein the second coating part is formed on an inner periphery of the diaphragm.

10. The loudspeaker diaphragm according to claim 1, wherein the coating layer has a weight in a range from 4 wt % to 8 wt %, inclusive, of a total weight of the diaphragm.

11. A loudspeaker comprising:
a frame;
the loudspeaker diaphragm according to claim 1, and having an outer periphery connected to the frame;
a voice coil coupled to a center part of the diaphragm; and
a magnetic circuit fixed to the frame, and having a magnetic gap into which the voice coil is inserted.

12. The loudspeaker according to claim 11, wherein the coating layer is formed on an inner periphery including the center part of the diaphragm to which the voice coil is coupled.

13. The loudspeaker according to claim 11, wherein the coating layer is formed on a surface opposite to a side at which the magnetic circuit is disposed.

14. The loudspeaker according to claim 11, wherein the coating layer includes:
a first coating part; and
a second coating part thicker than the first coating part,
wherein the voice coil is coupled to the second coating part.

15. An electronic device comprising:
a loudspeaker having:
a frame;
the loudspeaker diaphragm according to claim 1, and including an outer periphery connected to the frame;
a voice coil coupled to a center part of the diaphragm; and
a magnetic circuit fixed to the frame, and including a magnetic gap into which the voice coil is inserted; and
a signal processor electrically connected to the voice coil, and configured to supply an audio signal to the voice coil.

16. A mobile apparatus comprising:
a movable main body;
a driving unit mounted to the main body, and configured to move the main body;
a signal processor mounted to the main body; and
a loudspeaker having:
a frame;
the loudspeaker diaphragm according to claim 1, including an outer periphery connected to the frame;
a voice coil coupled to a center part of the diaphragm; and
a magnetic circuit fixed to the frame, the magnetic circuit including a magnetic gap into which the voice coil is inserted.
